(19) United States
(12) Patent Application Publication
(10) Pub. No.: US 2006/0136362 A1
(43) Pub. Date: Jun. 22, 2006

(54) Systems and methods for data conversion

(76) Inventors: Michael P. Jones, Highland, UT (US); Charles M. Whitmer, Highland, UT (US); Richard G. Hume, Draper, UT (US); Kevin B. Rogers, Newport Beach, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/021,102

(22) Filed: Dec. 22, 2004

(51) Int. Cl. G06F 17/30; G06F 7/00; G06F 3/00

(52) U.S. Cl. 707/1; 715/776; 707/7

(57) ABSTRACT

Data, such as pages of vehicle specification manuals, is received from reference information sources, in various formats, converted to a known format, and stored in a data store. Because all of the data is stored in a known format, users may more easily search information from multiple specification manuals. The pages of the specification manual that are stored in the data store are tagged according to content of the pages, so that pages of a specification manual that may be relevant to a specific diagnostic procedure, repair procedure, or system of the automobile may be easily located and transmitted to the user. The tags may also be used to generate multiple enhanced procedure lists including, for example, all categorized data that is relevant to a specific procedure, such as steps of the procedure and links to reference information related to steps of the procedure.

### BACKGROUND OF THE INVENTION

1. Field of the Invention

This invention relates generally to management of information useful in the automobile repair industry, and more particularly to automated generation of information to be used in conjunction with diagnostics and repair of motor vehicles.

2. Description of the Related Art

In the automotive repair industry, access to information regarding particular specifications of automobiles may be important, and sometimes essential, for properly diagnosing a symptom of an automobile and determining an appropriate repair procedure. Currently, many automobile manufacturers publish specification manuals that include detailed information regarding one or more automobiles. These manuals typically include a table of contents, multiple chapters directed to various portions of the automobiles, and an index. A technician at an automobile repair shop may use these specification manuals extensively in identifying symptoms and performing repair procedures.

In the recent past, many of the automobile specification manuals have been made available in an electronic format, such as in Adobe pdf format, so that users may store the manuals on a computer and view portions of the manual on a display device, as necessary. However, searching of these electronic specification manuals is generally limited, or, in some cases, not possible at all. Thus, the user typically must view the index or table of content portion of a manual on a display device in order to determine which pages of the electronic specification manual contain the desired information. Systems and methods for allowing the information in electronic specification manuals to be more easily and comprehensibly searched are desired.

In addition, information that may be relevant to a particular diagnostic or repair procedure may be found in multiple locations within a specification manual. Locating all of the information that may be relevant to a given procedure (including both diagnostic and repair procedures) is often complex and time consuming. Similarly, information that may be relevant to a particular system, or subsystem, of an automobile may be found in multiple locations within a specification manual, or in multiple specification manuals. Accordingly, systems and methods for organizing the information contained in specification manuals with respect to a particular matter are desired.

Currently, automobile specification manuals are available in various formats, which may vary from one vendor to another. Thus, a repair shop may have specification manuals in multiple formats that may be accessed in order to view information for automobiles. In order to simplify the use of this specification manual data by a repair shop, for example, systems and methods for converting automobile specification data from multiple vendors into a single format are desired. In addition, an interface that presents data from the specification manuals in one or more organized formats, thus providing the user with relevant information and easy access to the specification data, is desired.

### SUMMARY OF THE INVENTION

In one embodiment, a method of organizing data related to a vehicle to a known format comprises receiving information from a plurality of data sources in a plurality of formats, generating a plurality of pages based on the information received from the plurality of data sources, wherein the plurality of pages are each in the known format, assigning a tag to each of the plurality of pages according to content of the respective pages, storing the plurality of pages in one or more page stores, and storing a page list including an identifier for each of the stored plurality of pages.

In another embodiment, a method of converting data related to an object to a known format comprises receiving digital information from a plurality of data sources in a plurality of formats, generating a plurality of pages based on the information received from the plurality of data sources, wherein the plurality of pages are each in the known format, storing the plurality of pages in one or more page stores, and storing a page list including an identifier for each of the stored plurality of pages, wherein the identifier is applied to at least some of the plurality of pages according to rules that are automatically applied to the plurality of pages.

In another embodiment, a data structure comprises a field for storing information regarding a specific procedure that may be performed on a vehicle, a field for storing information regarding a particular vehicle system, a field for storing information regarding globally applicable reference items, and a field for storing information regarding a set of symptoms, wherein the information regarding the particular vehicle system, information regarding globally applicable reference items, and information regarding the set of symptoms are selected in response to selection of the specific procedure.

An one embodiment, a database comprises a plurality of records, wherein each of the records comprises a field for storing information regarding a specific procedure, a field for storing information regarding a particular vehicle system, wherein the particular vehicle system is related to the specific procedure, a field for storing information regarding globally applicable reference items, wherein the globally applicable reference items are related to the specific procedure, and a field for storing information regarding a set of symptoms, wherein the set of symptoms are related to the specific procedure.

In one embodiment, a method for compiling an enhanced procedure data file related to a specific procedure, wherein the enhanced procedure data file is compiled from information stored in a data store, comprises retrieving vehicle information regarding a vehicle on which the specific procedure is to be performed, retrieving procedure information from the data store related to the specific procedure, retrieving reference information from the data store, wherein the reference information comprises one or more informational items that are related to one or more steps of the specific procedure, and compiling the vehicle information, the procedure information, and the reference information into the enhanced procedure data file.

In another embodiment, a system of organizing data related to a vehicle to a known format comprises means for receiving information from a plurality of data sources in a plurality of formats, means for generating a plurality of pages based on the information received from the plurality of data sources, wherein the plurality of pages are each in the known format,

means for assigning a tag to each of the plurality of pages according to content of the respective pages, means for storing the plurality of pages in one or more page stores, and means for storing a page list including an identifier for each of the stored plurality of pages.

### BRIEF DESCRIPTION OF THE DRAWINGS

FIG. 1 is a block diagram illustrating the top-level components used in an exemplary system for converting data from one or more formats into a known useful format.

FIG. 2A is a block diagram illustrating modules that are included in the information management module of FIG. 1.

FIG. 2B is a perspective view of an exemplary computer system.

FIG. 3 is a flow diagram illustrating the movement of data that is received from various information sources in the generation of knowledge streams.

FIG. 4 is block diagram illustrating a data store configured so that labels may be more easily updated according to the rules.

### DETAILED DESCRIPTION OF CERTAIN EMBODIMENTS OF THE INVENTION

Embodiments of the invention will now be described with reference to the accompanying Figures, wherein like numerals refer to like elements throughout. The terminology used in the description presented herein is not intended to be interpreted in any limited or restrictive manner, simply because it is being utilized in conjunction with a detailed description of certain specific embodiments of the invention. Furthermore, embodiments of the invention may include several novel features, no single one of which is solely responsible for its desirable attributes or which is essential to practicing the inventions herein described.

The term “module,” as used herein, means, but is not limited to, a software or hardware component, such as a field programmable gate array (FPGA) or an application specific integrated circuit (ASIC), which performs certain tasks. A module may advantageously be configured to reside on an addressable storage medium and be configured to execute on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules.

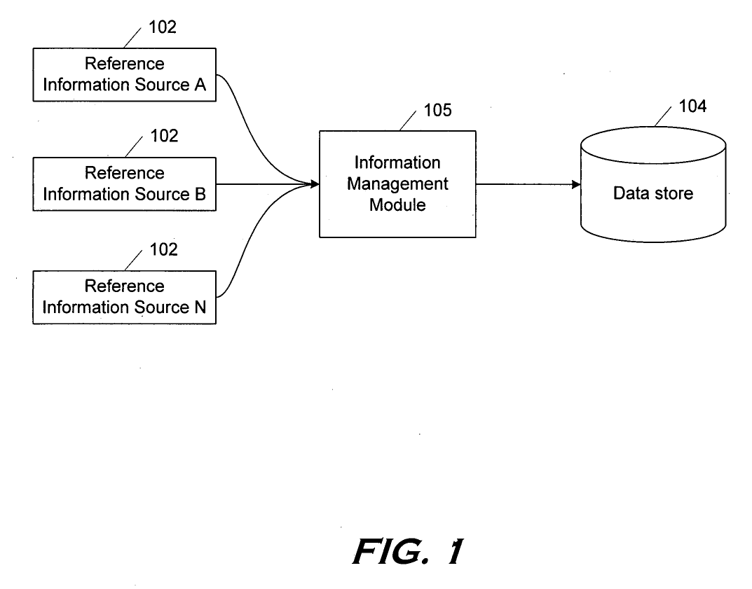

FIG. 1 is a block diagram illustrating the top-level components used in an exemplary system for converting data from one or more formats into a known useful format. As shown in FIG. 1, multiple reference information sources 102 are each in data communication with an information management module 105. In one embodiment, each of the reference information sources provides information regarding automobile specifications to the information management module 105. For example, Reference Information Source A may contain data regarding a Ford automobile, Reference Information Source B may contain data regarding a Toyota automobile, and Reference Information Source C may contain data regarding a Mitsubishi automobile. In one embodiment, one or more of the reference information sources 102 provides scanned images of specification manuals. In another embodiment, one or more of the reference information sources 102 provides digital character data, such as ASCII text, that corresponds to the text information in a specification manual. In this embodiment the reference information source 102 may also include images, such as may be stored in jpg (Joint Photographic Experts Group) format, that correspond to images included in a specification manual.

The information management module 105 is configured to receive data from multiple reference information sources 102, in various formats, and convert the information into a known format that may be stored in a data store 104 and accessed by a user interface. The information management module 105 is coupled to the data store 104, which is configured to store the converted information in the known format. Because all of the data is stored in a known format, users may more easily search information from multiple specification manuals and access the information with a single interface. As will be described in further detail below, the data stored in the data store 104 is advantageously tagged so that pages of a specification manual that may be relevant to a specific diagnostic procedure, repair procedure, or system of the automobile may be easily located and transmitted to the user.

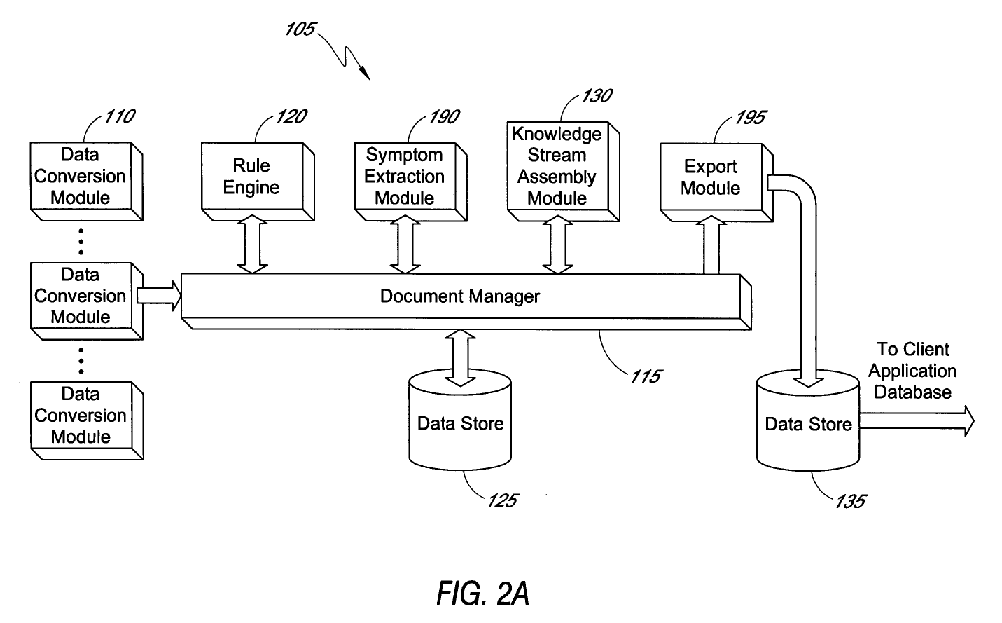

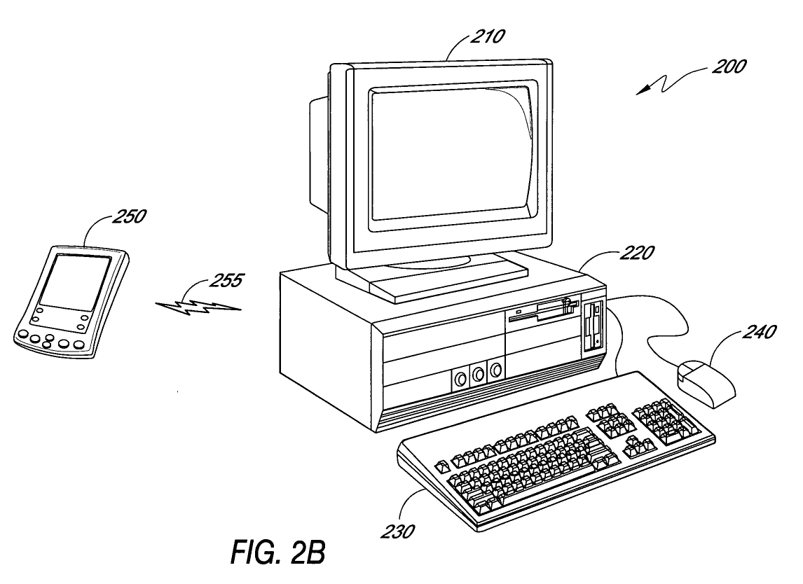

FIG. 2A is a block diagram illustrating modules that are included in the information management module 105 of FIG. 1. In one embodiment, each of the modules illustrated in FIG. 2A is located at the same location and interface with one another via direct data cable connections or a wired or wireless local area network (“LAN”), for example. In another embodiment, one or more of the modules illustrated in FIG. 2 are located remote from the other modules and communicate with the document manager 115 via a wide area network (“WAN”), such as the Internet. In another embodiment, the modules illustrated in FIG. 2A are each software objects stored on a single computing device.

As shown in FIG. 2A, the exemplary information management module 105 includes a document manager 115 coupled to each of the other illustrated modules. In an advantageous embodiment, the document manager 115 comprises a computing device running an operating system, such as a PC, MAC, or LINUX based operating system. The document manager 115 is advantageously configured to communicate with various devices and receive input in various formats. In addition, the document manager 115 is configured to output information to various devices and in various formats.

FIG. 2B is a perspective view of an exemplary computer system 200. In one embodiment, the document manager 115 comprises a computing device, such as the computer system 200. In addition, each of the users, such as an automobile repair shop, comprises one or more computing devices that are similar to the computer system 200. The exemplary computer system 200 comprises a display 210 coupled to a computer 220. The computer system 210 may be coupled to one or more computing devices via any type of networking connection. A plurality of user input devices may be coupled to the computer 200, such as a keyboard 230 and a mouse 240. The user input devices may also include a touch screen, joystick, trackball, and microphone, for example. The peripheral devices listed above, and any other available peripheral devices, may be coupled to the computer 110 via wired or wireless connections, and the computer 220 may be coupled to a network via a wired or wireless connection. As will be appreciated by those skilled in the technology, the computer system 200 as described herein is not limited to the device illustrated in FIG. 2, but may be, for example, a personal digital assistant (PDA), cellular telephone, pager, or any computing device configured to display text, images or sounds (signs) to a user.

In the embodiment of FIG. 2B, a portable computing device 250 is in communication with the computer 220 via a wireless communication link. In one embodiment, the portable computing device 250 comprises a notebook or tablet computer. In another embodiment, the portable computing device 250 comprises a personal digital assistant (PDA), a cell phone, or any other suitable electronic device comprising a display and an information processor. In an advantageous embodiment, the data generated by the information management module 105 may be accessed by the computer system 200, which may be located at an automobile repair shop, for example.

Returning to FIG. 2A, the Data conversion modules 110 are each configured to receive data from one or more different data sources, such as information providers at Mitsubishi, Honda, Ford, General Motors (“GM”). For example, one of the data conversion modules 110 may be configured to receive automobile specification data in XML format from Mitsubishi Motors, while another data conversion module 110 may be configured to receive automobile specification data in PDF format from Ford Motors and yet another data conversion module 110 is configured to receive automobile specification data in another format from GM.

In an advantageous embodiment, the data conversion modules 110 convert the received information into a known format and classify portions of the information into one or more of several views. In one embodiment, these views include a table of contents view, a type view, and an extracted view. The table of contents view indicates the hierarchal organization of pages included in the specification manual. In one embodiment, each of the pages of a specification manual is stored in a database. An identifier for each of the pages may then be stored in a separate page list, and references to the identifiers of these pages may be organized in various manners. Each of these various organizations of pages, or organizations of page identifiers, comprises a page view. For example, a table of contents view may contain section headings included in the specification manual along with a pointer to the identified pages stored in a storage device. Thus, the table of contents view provides a sequential hierarchy of the information contained in a specification manual.

In one embodiment, a type view classifies pages of the specification manual into page types, which may include, for example, component, diagnostic, and special tools pages. The type view may further classify the pages into procedures so that by accessing the type view, a user may determine all pages that relate to a particular procedure category. For example, a type view may classify pages into one of multiple different procedure types, such as DTC trouble shooting procedures, component inspection procedures, or repair procedures. Thus, a user may easily locate all circuit diagrams, for example, by accessing the circuit diagram section within the type view of a manual. In one embodiment, many of the pages in the table of contents view are also referenced in the type view. For example, in one embodiment the table of contents view includes all pages, while the type view includes a subset of the pages in the table of contacts view. Thus, identifiers for many pages may be included in multiple views and the identified pages may be located from different views. For example, a specification manual may be converted by the data conversion module 110 to include a special tools view, including an identifier for a page dealing with the use of an oil filter removal tool. The identifier for this same page may also be listed in the table of contents view as a subtopic of an engine care section of the specification manual, for example.

In another embodiment, identifiers for some pages of the specification manual are included in an extracted view, which further classifies content on the pages. For example, portions of a procedure page in the type view may be classified as (1) steps in the procedure or (2) reference information that is specific to that procedure.

In some instances, the data received from a data source identifies pages that correspond with each of the views used by a particular data conversion module 110. In this embodiment, the pages may be classified into one or more views according to the data received from the data source. In another embodiment, the data received from the data source does not include any information that classifies pages into views. Thus, in this embodiment, the pages are analyzed, by machine and/or human recognition, in order to classify the pages into one or more views.

The information management module 105 also includes a data store 125, which may be any type of storage device, such as a hard drive or optical storage device. The information stored on the data store 125 may be organized and physically stored on data store 125 according to any methods known in the art. When the various views, discussed above, are generated from the data received from one or more data sources, the views are stored in the data store 125. The data store 125 is advantageously electronically coupled to the other modules of the information management module 105 so the views may be accessed by any of these modules and so that additional information may be stored and accessed on the data store 125.

Rule engine 120 is configured to receive the pages that have been accessed by the data conversion modules 110 and to classify the pages into one or more categories. The rule engine assigns tags or labels to each page in the page store. The tags reflect the various categorizations of each page. These tags are later used by the knowledge stream assembly module 130. In one embodiment, pages received from the data conversion modules may be classified into one or more of three groups, namely, global reference information, system reference information, or procedure descriptions.

Global reference information may include, for example, pages including information that a user will want to access no matter what task they are working on. For example, pages including contact information for the vehicle manufacturer and information regarding translation of a VIN number into a model number may be classified as global reference information.

System reference information is information that relates to a particular automobile system, such as the transmission, engine, or brakes, for example. In one embodiment, subsystems, such as fuel injection, heating/cooling, and electrical subsystems related to an engine, for example, may also be included as automobile systems. Thus, the pages from the various specification manuals may be categorized at varying levels according to the systems, or subsystems, to which the information relates.

Procedure descriptions generally describe a diagnostic, maintenance, or repair procedure (referred to herein generally as procedures). Typically, these procedures have specific steps for performing the procedures, and may also have pieces of reference information within them that are specific to each procedure. For example, repair procedures included in many specification manuals are organized into tables that include steps to be taken in performing each procedure. In one embodiment, a procedure description is in the form of a table or a list. In other embodiment, the procedure descriptions are organized in other formats known in the art.

A symptom extraction module 190 is coupled to the document manager 115 and is configured to identify symptoms for which diagnostic procedures may be relevant. The association of symptoms to a specific procedure may be useful in further categorizing those pages into a more granular view of the data.

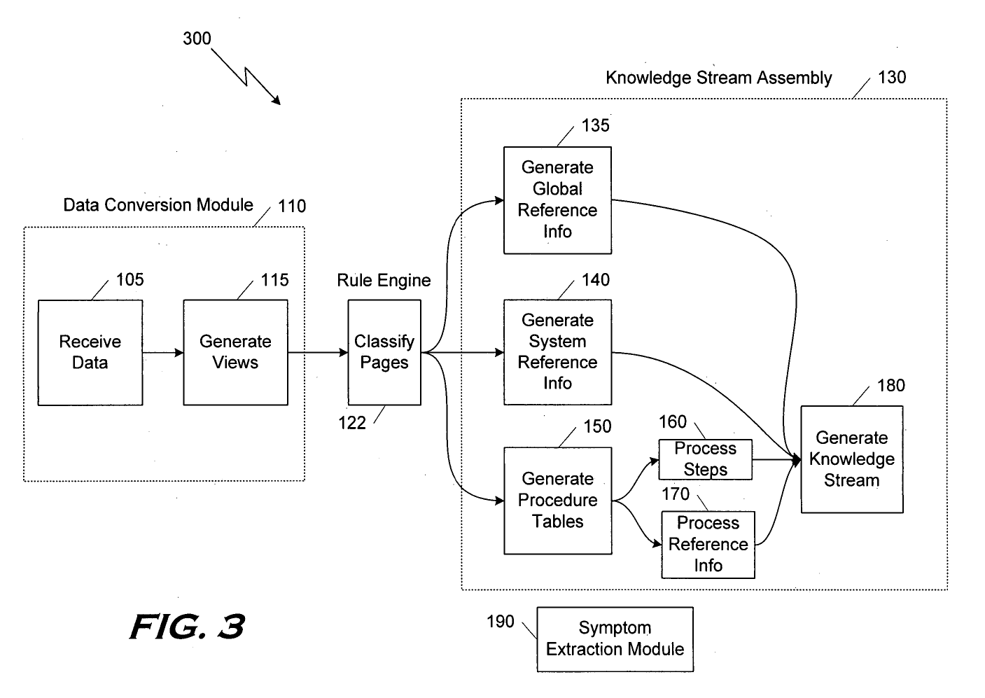

A knowledge stream assembly module 130 is coupled to the document manager 115. After the data pages have been categorized using the above-described modules, the knowledge stream assembly module compiles the pages into multiple enhanced procedure lists, referred to herein as “knowledge streams.” In one embodiment, the knowledge stream assembly module 130 processes the categorizations of the rules engine 120 in order to generate knowledge streams. For example, all categorized data that is relevant to a specific procedure may be combined into a knowledge stream including the procedure itself with steps of the procedure having links to all of the reference information related to that step, or the entire procedure. Further details regarding the generation and content of knowledge streams are included below with reference to FIG. 3.

An export module 195 is coupled to the document manager 115 and is configured to change the format of the data maintained in the data store 125 according to the various requirements of users. For example, some users request that knowledge streams, or other data, be formatted for viewing on a portable device with specific dimensions, while other users may request knowledge streams in other formats and may also request copies of all specification manual pages referenced in a knowledge stream. In one embodiment, the pages, or other data, requested by users is converted by the export module 195 and stored in a data store 135 until retrieved by the requesting user. For example, the requested data may be formatted for storage as one or more XML documents. In another embodiment, the converted data may be stored in the data store 135 even after the requesting user has retrieved a copy of the data. Thus, the data may be retrieved by other users that request the same data in the same format. This may be advantageous, for example, if a chain of automobile repair shops require data in a particular format. In this example, by storing the converted data in the data store 135, the data may be accessed by any of the chain of repair shops without the need to reconvert the same data.

When a requesting user receives the requested data, such as a knowledge stream (discussed in further detail with respect to FIG. 3), the user may manipulate the data for presentation on one or more display devices. For example, portions of the requested data may be extracted for viewing in separate panes that are presented on a display device.

FIG. 3 is a flow diagram illustrating the movement of data that is received from various information sources in the generation of knowledge streams. As illustrated in FIG. 3, the process has been divided into steps performed by the data conversion module 110, the rule engine 120, the knowledge stream assembly module 130, and the symptom extraction module 190. While methods are described below with respect to specific modules, any of the steps illustrated in FIG. 3 may be performed by any of the other illustrated modules, or any other component of the information management module 105.

In a step 105, data from a data source is received by the data conversion module 110. As described above, the data may be in one of many different formats and may be received from various data sources. In one embodiment, pages of a specification manual are received by the data conversion module 110 in a graphic format, such as in PDF, JPG, or TIF format. For purposes of illustration, the description below often refers to classification of pages, referring to pages of an automobile specification manual. However, any reference herein to a page should be read to cover any other data, such as a portion of a page or electronic data.

Continuing to a step 115, the data conversion module 115 classifies portions of the data into one or more of several views. In one embodiment, each page of a specification manual is included in one or more views. In one embodiment, these views include a table of contents view, a type view, and an extracted view. In another embodiment, additional, or fewer, views may be used in categorizing received data.

Moving to a step 122, the rule engine 120 classifies and labels data, such as pages or portions of pages, into one or more classifications. These classifications may then be stored in the data store 125 for access by other modules of information management module 105. As described above, in one embodiment, pages may be classified into one or more of three classifications, namely, global reference information, system reference information, or procedure descriptions.

In one embodiment, rules are applied to the content of the received data, such as on a per page basis, in order to categorize and label each page, or portion of a page, properly. In one embodiment, automatic rules, manual rules, and inherited rules may each be used to classify data. In an advantageous embodiment, the automatic rules are applied first, followed by inherited rules, and then manual rules. Thus, after application of the automatic rules, data that was not classified automatically may be classified according to manual or inherited rules. Each of these rule types is described further below. In addition, other types of rules may also be applied to the received data.

Automatic rules are typically applied by a computing device without the need for human input. For example, in one embodiment, an automatic rule includes an algorithm that identifies certain features on a page, assigns a score for each of these features, and based upon the total of the scores for the page, determines that the page should be classified into a particular category. Automatic rules may be generated by a human or by artificial intelligence training, for example. In either case, automatic rules are able to automatically take a piece of content, analyze the content, and determine one or more labels that should be applied to the content.

Automatic rules may be defined to identify certain features of a procedure description, for example, so that a procedure description may be automatically identified. For example, if a symptom table, which is basically a table with a list of symptoms, includes a link to a particular page, the automatic rules may score the particular page as including a procedure description. If the word “procedure” appears in bold letters in a heading position, the data may get another score indicating that the data includes a procedure description. Other scores may also be assigned to a page indicating that the page is another category of information, such as a symptom table, for example. After the rules are applied to a page, the scores are summed and the page is categorized based on the various sums. In one embodiment, threshold score totals for categorizing data into a specific category are established. For example, if four scores indicate that data contains a procedure description, and no other category received more than one score, the data may be categorized as containing a procedure description. In a similar manner, other categories may be assigned to data based upon common features that are in each type of information.

In another embodiment, automatic categorization of pages, such as categorization of pages as procedure descriptions, may be performed by the data conversion module 110.

In one embodiment, information that cannot satisfactorily be classified automatically may be classified manually by a person. For example, if a page has not been classified by an automatic rule, a person may view the page on a computer display device and determine the appropriate label, or labels, that should be applied to the page. This process generates a manual rule that the system can reapply in the future. Thus, the manual rule generation effort must be performed only once for a particular data set.

Inherited rules are a collection of manual rules applied to a new data set. In one embodiment, the system automatically determines which rules from the collection are productive within the new data set. The inherited rules look for sections of data that correspond with data that has already been categorized. The section of data, such as a page, a portion of a page, or multiple pages, may then inherent the same classifications as the data that was previously categorized. For example, if a set of classification rules is developed that applies to the specification manual for the 2003 Galant, the system may determine that some of the classification rules are applicable to the specification manual for the 2004 Galant. Thus, portions of the data from the 2004 Galant manual may be categorized using the categorizations that were used for the 2003 Galant manual. In an advantageous embodiment, inherited rules that apply to particular data are determined automatically so that manually generated rules may be used to categorize any portions for which inherited rules are not appropriate. In one embodiment, inherited rules are developed based on the analysis of multiple manuals and the determination of structures that are common across the analyzed manuals. Accordingly, the common structures in multiple manuals may be used to generate a template for inheritable rules.

After the data pages have been categorized using the above-described processes, a knowledge stream assembly module 130 generates multiple enhanced procedure lists, referred to as Knowledge Streams, based on the page categorizations received from the data conversion module 110 and rule engine 120. At this point, all pages are labeled as a complete process description, a step in a process, a piece of reference material related to a particular process, a piece of reference information related to a particular system in the automobile, or a piece of reference information that is generally related to an automobile, for example. The knowledge stream assembly module 130 accesses these categorizations in order to generate knowledge streams.

In a step 135, the knowledge stream assembly module 130 generates global reference information for use in all knowledge streams. In one embodiment, a knowledge stream may be directed specifically to global reference information so that a user may retrieve any global reference information from a single knowledge stream. The global reference information may also be compiled for use in other knowledge streams.

In a step 140, the knowledge stream assembly module 130 generates system reference information for use in one or more knowledge streams. For example, all information regarding a transmission system may be compiled for use in one or more knowledge streams. This exemplary compilation of transmission system information may include links to other similar procedures relating to the transmission system. As described above, a system may be either a broad system of the automobile, such as transmission, engine, or electrical, or system may include a subsystem, such as fuel injection, power seats, or brake pads, for example. Thus, depending on the level of granularity to which the information management module 105 is set, information regarding fewer or more automobile systems may be generated at step 140.

In a step 150, the knowledge stream assembly module 130 collects procedure description information for use in creating knowledge streams. In one embodiment, a procedure description is linked to information regarding a specific system by identifying a procedure as applying to that system.

In one embodiment, the data that has been categorized as a procedure description may be further categorized. For example, as illustrated in FIG. 3, at a step 160, steps of a procedure are processed and at a step 170 reference information included in a procedure description is processed. In one embodiment, steps 160 and 170 categorize the entire procedure description, or portions of the description, as either steps to be performed in a repair or diagnostic procedure, or as reference information. Thus, the data that is categorized as a procedure description in step 150 may be split into more narrow categorizations. For example, one type of reference information may include probable cause information, such as a list of things that might have caused the condition that is being diagnosed. Another type of reference information may be Diagnostic Trouble Codes (“DTC”), which is information read from an automobile's computer.

Continuing to a step 180, data that is categorized and processed by the previous steps, is combined into knowledge streams. As noted above, a knowledge stream may include a procedure itself, along with steps of the procedure, and include links to reference information corresponding to specific steps, or corresponding to the entire procedure or the automobile in general.

In one embodiment, knowledge streams are organized in a hierarchical structure. For example, a top level of the hierarchy may identify the specific knowledge streams, as well as other information that may help to identify the knowledge stream, such as a type of the knowledge stream. In a next level of the hierarchy, a number of folders may be linked to each knowledge stream, where the folders contain the various content items associated with the knowledge stream. For example, a knowledge stream may contain individual steps in a process, pieces of reference information that are specific to a procedure, reference information for a system, and global reference information. Thus, by selecting a particular knowledge stream, various informational items may be easily retrieved by the user.

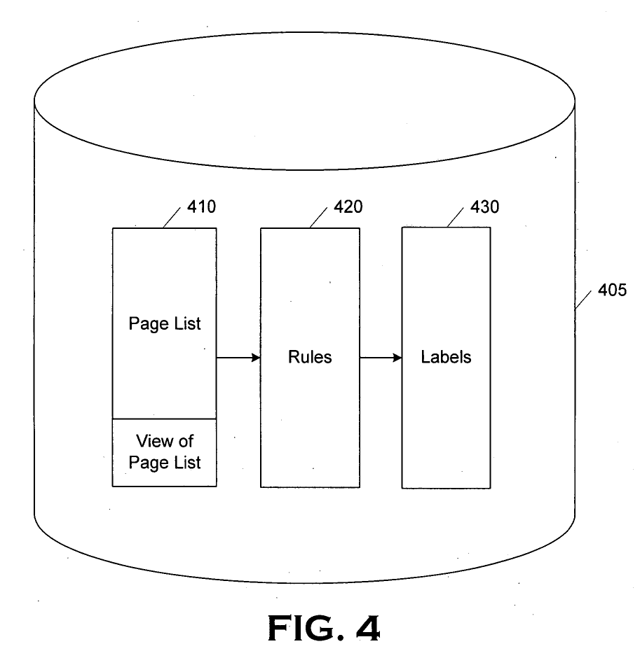

FIG. 4 is block diagram illustrating a data store 405 configured so that labels may be more easily updated according to the rules. In the past, pages were typically associated directly with one or more labels for that page. However, if one of the rules responsible for applying a label to a page was changed so that a label for a page should be changed, there was no easy way to update labels based on the current rules. As shown in FIG. 4, the data store 405, which may be a data base, for example, stores a page list, rules associated with each page, and labels for each of the pages, as generated by the rules. In one embodiment, the page list includes an identifier for each page, where the actual pages are stored separately. The page references stored in the page index may be viewed according to one or more views, which may also be stored in the data store 405. Advantageously, rules are generated for classification of particular pages (listed in the page index) so that a page may be classified according to the generated rules. Because rules are generated and stored, rather than just the specific classifications for the pages, these rules may be applied to subsequent pages, thus reducing the effort required to classify subsequent pages. For example, related pages, such as pages of a specification manual for a different year of the same model automobile, may be classified using the same rules. Accordingly, rules may be generated once and applied multiple times to a collection of pages if necessary. This approach accommodates the need to regenerate the base data (as changes are made, etc.) without losing the labeling effort that has already been performed.

The foregoing description details certain embodiments of the invention. It will be appreciated, however, that no matter how detailed the foregoing appears in text, the invention can be practiced in many ways. As is also stated above, it should be noted that the use of particular terminology when describing certain features or aspects of the invention should not be taken to imply that the terminology is being re-defined herein to be restricted to including any specific characteristics of the features or aspects of the invention with which that terminology is associated. The scope of the invention should therefore be construed in accordance with the appended claims and any equivalents thereof.

What is claimed is:

1. A method of organizing data related to a vehicle to a known format, the method comprising:
receiving information from a plurality of data sources in a plurality of formats;
generating a plurality of pages based on the information received from the plurality of data sources, wherein the plurality of pages are each in the known format;
assigning a tag to each of the plurality of pages according to content of the respective pages;
storing the plurality of pages in one or more page stores; and
storing a page list including an identifier for each of the stored plurality of pages.

2. The method of claim 1, further comprising generating a table of contents view of at least a portion of the plurality of pages, wherein the table of contents view comprises pointers to sections of at least a portion of the plurality of pages.

3. The method of claim 2, wherein at least a portion of the plurality of pages comprises pages related to a specific make, model, and year of automobile.

4. The method of claim 1, further comprising generating a type view of at least a portion of the plurality of pages, wherein the type view categorizes each page according to the content of the respective page, as determined by the tag assigned to the respective page.

5. The method of claim 1, wherein the tags are indicators of content on their respective pages, wherein the content indicators are selected from the group comprising: a procedure, a component, a diagnostic, and a special tool.

6. The method of claim 1, wherein the vehicle is selected from the group comprising: an automobile, a water vehicle, and an aircraft.

7. The method of claim 1, wherein at least one of the plurality of data sources comprises reference information common to an entire vehicle.

8. The method of claim 1, wherein at least one of the plurality of data sources comprises reference information common to a subsystem of a vehicle.

9. The method of claim 1, wherein at least one of the plurality of data sources comprises reference information related to a diagnostic or maintenance procedure.

10. A method of converting data related to an object to a known format, the method comprising:
receiving digital information from a plurality of data sources in a plurality of formats;
generating a plurality of pages based on the information received from the plurality of data sources, wherein the plurality of pages are each in the known format;
storing the plurality of pages in one or more page stores; and
storing a page list including an identifier for each of the stored plurality of pages, wherein the identifier is applied to at least some of the plurality of pages according to rules that are automatically applied to the plurality of pages.

11. The method of claim 10, wherein the object is selected from the group comprising: vehicles, office equipment, electronics, appliances, computer hardware, computer software, office equipment, home maintenance equipment, housewares, fitness equipment, baby gear, video games, products, and services.

12. A data structure stored in a storage device, the data structure comprising:
a field for storing information regarding a specific procedure that may be performed on a vehicle;
a field for storing information regarding a particular vehicle system;
a field for storing information regarding globally applicable reference items; and
a field for storing information regarding a set of symptoms, wherein the information regarding the particular vehicle system, information regarding globally applicable reference items, and information regarding the set of symptoms are configured for selection by a software application in response to selection of the specific procedure.

13. The data structure of claim 12, wherein the specific procedure is selected from the group comprising: a DTC troubleshooting procedure, a component inspection procedure, and a repair procedure.

14. The data structure of claim 12, wherein the particular vehicle system is selected from the group comprising: exhaust system, support system, engine, steering system, power train, electrical system, coolant system, fuel system, and brake system.

15. The data structure of claim 12, wherein the particular vehicle system is selected from the group comprising: muffler, tailpipe, fuel tank, shock absorbers, coil springs, drum brake, fuel line, accelerator, brake pedal, distributor, differential, master brake cylinder, disk brake, transmission, spark plug wires, exhaust manifold, engine, radiator, alternator, coolant reservoir, intake manifold, batteries, brake line, and steering wheel.

16. A database comprising a plurality of records, each of the records comprising:
a field for storing information regarding a specific procedure;
a field for storing information regarding a particular vehicle system, wherein the particular vehicle system is related to the specific procedure;
a field for storing information regarding globally applicable reference items, wherein the globally applicable reference items are related to the specific procedure; and
a field for storing information regarding a set of symptoms, wherein the set of symptoms are related to the specific procedure.

17. A method for compiling an enhanced procedure data file related to a specific procedure, wherein the enhanced procedure data file is compiled from information stored in a data store, the method comprising:
retrieving vehicle information regarding a vehicle on which the specific procedure is to be performed;
retrieving procedure information from the data store related to the specific procedure;
retrieving reference information from the data store, wherein the reference information comprises one or more informational items that are related to one or more steps of the specific procedure; and
compiling the vehicle information, the procedure information, and the reference information into the enhanced procedure data file.

18. A system of organizing data related to a vehicle to a known format, the system comprising:
means for receiving information from a plurality of data sources in a plurality of formats;
means for generating a plurality of pages based on the information received from the plurality of data sources, wherein the plurality of pages are each in the known format;
means for assigning a tag to each of the plurality of pages according to content of the respective pages;
means for storing the plurality of pages in one or more page stores; and
means for storing a page list including an identifier for each of the stored plurality of pages.
